(19) United States
(12) Patent Application Publication
(10) Pub. No.: US 2026/0147648 A1
(43) Pub. Date: May 28, 2026

(54) SYSTEM AND METHOD FOR SOFTWARE APPLICATION DEVELOPMENT INCLUDING PORTABLE AND EXTENSIBLE DYNAMIC USER INTERFACES AND DATA VALIDATION

(71) Applicant: ORACLE INTERNATIONAL CORPORATION, Redwood Shores, CA (US)

(72) Inventors: CHRISTIAN STRAUB, Palo Alto, CA (US); JING WU, Palo Alto, CA (US); BLAKE SULLIVAN, San Mateo, CA (US); JOHN SMILJANIC, Austin, TX (US); GRAHAM CARON, Reno, NV (US)

(21) Appl. No.: 18/962,845

(22) Filed: Nov. 27, 2024

(51) Int. Cl. G06F 9/54

(52) U.S. Cl. CPC G06F 9/547

(57) ABSTRACT

Embodiments described herein are generally directed to client/server software application development frameworks, and are particularly directed to systems and methods for supporting portable and extensible dynamic user interfaces and data validation. An application development framework is provided, wherein a rules engine component and rules are provided at both the client-side and the server-side, for use with a particular application. The rules engine and rules can be different implementations at each end. The client and server can communicate to exchange the latest versions of the rules; however the rules themselves are agnostic as to which (client-side or server-side) engine they are run on. The system allows users to configure policies associated with a client-side user interface and a backend server, that operate together to provide application portability and extensibility, for example to control the presentation, logic, defaulting, and operation of a data set associated with a dynamic user interface.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

Embodiments described herein are generally directed to client/server software application development frameworks, and are particularly directed to systems and methods for supporting portable and extensible dynamic user interfaces and data validation.

### BACKGROUND

Software development environments allow application developers to develop software applications. When an application is used in a client/server environment, the client may be running in a different operating environment which is completely independent from a server holding the proof of record. For example, a web application running in a client-side browser could present and allow a user to interact with a user interface (UI) and fields therein, without first consulting the server.

In data-driven applications that use dynamic user interfaces, configuration of the client-side user interface may include requirements directed to defaulting and validations. For example, based on a current end user's geographic location, certain default values might appear in some fields of the user interface. Other fields within the client-side user interface may not be relevant to that particular user, and should be removed all together. Yet other fields might require an additional validation of the end user input, before communicating the user input to the server.

When an application developer incorporates such defaulting, validation or other features into their application, they are faced with some challenges. For example, the application developer could elect to hardcode certain features within the client-side application, to provide a degree of functional security. However, since these features are written in the language of the client (which may be different from that of the server), this may result in aspects such as validations only occurring on the client. Such an approach might, for example, result in an end user submitting data directly to the server without applying the anticipated validations required by the server. To address this gap, the application developer would then need to reimplement the same set of (e.g., validation) features on the server, and have them that precisely match what is provided on the client.

In addition, if an application developer elects to hardcode certain features within the client-side application, it may become difficult for a third-party company or partner to later modify the application without obtaining and modifying the underlying source code. Maintenance of the application becomes difficult over time, as new features built by the application developer must be pulled and adopted by that third-party company or partner.

An alternative approach is for the application developer to hardcode certain features on the server, to provide actual security. On the client, every time a change is made (for example a user types a user input into a displayed form field), the client can consult with the server, determine if that change is valid and/or needs to affect the form in some way, and then perform the changes via those instructions.

Although this approach provides aspects of both functional security and actual security, disadvantages include increased client-server communication load, which reduces performance; and also that the client must be connected to the server and therefore offline support with the same set of features is no longer possible.

Another approach is to use the same programming language on both the client-side and server-side, and provide a library that can be run on both the client and the server separately. However, in addition to presenting issues with extensibility (since it still utilizes hardcoded instructions), this approach is often impracticable or difficult to achieve in practice since it relies on the client and server agreeing on a same language, set of frameworks, behaviorisms and other such constructs.

The above examples illustrate the significant issues that can arise in developing data-driven applications that use dynamic user interfaces, and how such issues can lead to errors and mistakes as code needs to be duplicated to accommodate for differences or changes in the client/server environments.

### SUMMARY

Embodiments described herein are generally directed to client/server software application development frameworks, and are particularly directed to systems and methods for supporting portable and extensible dynamic user interfaces and data validation.

In accordance with an embodiment, an application development framework is provided, wherein a rules engine component and rules are provided at both the client-side and the server-side, for use with a particular application. The rules engine and rules can be different implementations at each end. The client and server can communicate to exchange the latest versions of the rules; however the rules themselves are agnostic as to which (client-side or server-side) engine they are run on.

In accordance with an embodiment, the system allows users to configure policies associated with a client-side user interface and a backend server, that operate together to provide application portability and extensibility, for example to control the presentation, logic, defaulting, and operation of a data set associated with a dynamic user interface. Once authored, the rules can run simultaneously and independently across both a UI client (e.g., a web browser) and a backend server. These rules can be extended by further rule sets enabling, for example, a company to offer a base set of rules and have their customers configure and append new rules to operate in the same manner.

In accordance with an embodiment, a method for portable and extensible system for dynamic user interfaces and data validation can be provided. The method can provide a computer comprising one or more microprocessors. The method can provide, at a computing environment running on the computer, a server. The method can run, at the server, a rules engine. The method can provide, by the server, one or more application programming interfaces (APIs) for use by a client. The method can, upon receiving a first communication from the client, determine, from a plurality of rule sets, a rule set and transferring, via the one or more APIs, the determined rule set to the client. The method can run the determined rule set at the rules engine, wherein running the rule set at the rules engine utilizes context and data accessible by the rules engine.

### BRIEF DESCRIPTION OF THE DRAWINGS

FIG. 1 illustrates an example server environment for portable and extensible system for dynamic user interfaces and data validation, in accordance with an embodiment.

FIG. 2 illustrates an example server environment for portable and extensible system for dynamic user interfaces and data validation, in accordance with an embodiment.

FIG. 3 illustrates an example server environment for portable and extensible system for dynamic user interfaces and data validation, in accordance with an embodiment.

FIG. 4 illustrates an example server environment for portable and extensible system for dynamic user interfaces and data validation, in accordance with an embodiment.

FIG. 5 illustrates an example server environment for portable and extensible system for dynamic user interfaces and data validation, in accordance with an embodiment.

FIG. 6 illustrates an example server environment for portable and extensible system for dynamic user interfaces and data validation, in accordance with an embodiment.

FIG. 7 illustrates an example flow chart for portable and extensible system for dynamic user interfaces and data validation, in accordance with an embodiment.

FIG. 8 is a flowchart of a method for portable and extensible system for dynamic user interfaces and data validation, in accordance with an embodiment.

FIG. 9 illustrates an example user interface, in accordance with an embodiment.

FIG. 10 illustrates an example user interface, in accordance with an embodiment.

### DETAILED DESCRIPTION

In accordance with an embodiment, generally described are systems and method for providing a rules-based engine that takes as input the current state of the data, any external and relevant context, and events occurring that could modify that data. It then runs a series of rules to determine the set of changes that should be applied over the data. This can affect the data structure directly (hide/unhide certain fields from evaluation or in the UI), change the behavior of data entry (make a field required), provide default or new values, or add new validations. These rules are run in series. This means a rule may provide some result, but another rule run layer may override that result. Each rule can decide whether or not it should perform its work by evaluating the current state of the data, and the relevant environment context.

In accordance with an embodiment, embodiments described herein are generally related to systems and methods that allow users to configure various dynamic policies of a user interface and a backend server simultaneously. Through a rules-based mechanism, this includes policies that can affect the presentation, logic, defaulting, and operation of a data set. Once authored, these rules can run simultaneously and independently across both a UI client (e.g., a web browser) and a backend server. These rules can be extended by further rule sets enabling. This would allow, for example, a company to offer a base set of rules and have their customers configure and append new rules to operate in the same manner.

In accordance with an embodiment, for example, rule A might state that if a user is based in Germany, and has level 80 or higher in the company, then the user should be able to provide additional information in a form that will be submitted and entered in the system of record. A similar rule could also say that if those same conditions are met, that additional data should be validated against some external data set for accuracy.

In accordance with an embodiment, rule sets can be rerun dynamically when either the current state of data or the environment context changes. For example, if a rule has a condition that checks for a field being true, if a user set that field to true in a user interface, the set of rules would be rerun, the rule would then apply, and its effect would take place.

In accordance with an embodiment, this system of rules is designed to be portable. It can be written in a generic format and uses generic expressions like syntax to create rule conditions and effects. The system includes facilities to interpret and execute these rules in both a client and server environment. This makes the rule set portable so that it is authored once, but it can take effect in multiple environments (as many as supported by the system).

In accordance with an embodiment, for example, a user interface can be provided on a web application that runs in a web browser where a user is entering data via a form. A server takes/receives the data entered via the web browser and writes it to a database that is accessible by the server.

In accordance with an embodiment, continuing the above example, the system can run completely and independently in the web browser, when the form is first presented, it can have the correct default values (as specified by rules configured in the system). As the user enters and modifies data on the form, the form presentation can react and be modified (again by applying rule instructions). Finally, as the user enters data, and prior to submitting the form, validations inserted by rules (configured in the system) can be run and provide instant feedback. All of this occurs without communicating anything to the server (all the information to default, change the UI, and validate is on the client, and its run only there). This also means the client can run in a completely offline environment (for example in airplane mode, or where the client device does not have internet and/or data communication) and still have all the same behaviors. Since the client interface does not have to communicate with the server, this leads to a much more performant experience as everything is calculated and performed locally.

In accordance with an embodiment, continuing the above example, when the user submits that same form to the server (e.g., after completing the form, or after re-establishing internet and/or data communication), the same system and set of rules are available on the server. The server applies the same defaults (e.g., in case some fields are not sent), performs the same data integrity checks, and runs all custom validations as configured by the rules.

In accordance with an embodiment, in this case, the rules author does not have to worry about a malicious end user communicating with the server, since every logical rule they wrote is fully portable across both environments, namely the client (e.g., the client application running on or in a web browser), and the server.

In accordance with an embodiment, another benefit provided by the disclosed systems and methods, in addition to the portability described above, is extensibility. Often, software sold as a service will need to be tweaked by a customer for their specific work flows and to match company policies, etc. The system allows these sorts of customers (or partners) to deploy new sets of rules to the system. These rules are authored exactly like rules coming from the original application authors but are layered above those rules in evaluation. That means a customer could override or tweak the default behaviors of the app, remove or add validations, and affect data transformations just as the original app author could. Since rules deployed by that customer operate in the same way as the original author, all of these rules are still authored exactly once, and then become automatically portable across client/server stacks.

In accordance with an embodiment, this also means that the original author can add additional rules and behaviors over time freely and without coordinating with the customer. As these rule sets are distinct and separable, it allows both the original author and the customer to develop these rule sets independently and in with different schedules.

In accordance with an embodiment, the systems and methods can be provided as an extensible system that allows multiple authors to contribute to the same configuration independently (while still maintaining portability).

In accordance with an embodiment, the systems and methods are advantageous as it lessens/eliminates code duplication where one piece of code executes on a client, and a completely different piece of code executes on the server (and has to be synced manually in code by a developer).

In accordance with an embodiment, the systems and methods are advantageous as they provide choice in client and server tech stack and language choice.

In accordance with an embodiment, the systems and methods are advantageous as they provide for improvement in remote client performance as all work can be done locally on the client.

In accordance with an embodiment, the systems and methods are advantageous as they provide for features to work completely if the client is completely disconnected (offline), or only intermittently connected to a server.

In accordance with an embodiment, the systems and methods are advantageous as they allow for the same facilities to be performed by multiple actors (a company, its customers, their customers, partners, etc.) without having to fork source code, or keep code in sync across all parties.

In accordance with an embodiment, a set of files can be provided and/or configured where each file can comprise/contain a rule set. A rule set can comprise series of rules that contain a condition and a behavior. The rule set can take as input a set of data that represents the data being examined or modified. It also takes in any relevant environmental context for rule evaluation.

In accordance with an embodiment, a rule condition can examine the data set or the environmental context to decide whether or not it is active. If it is active, then the rule can provide a payload that describes what it is intended to do and also how to do it. This behavior may rely on the data set or environment context to further influence how that behavior is performed.

In accordance with an embodiment, a rules engine can run the rules in series. If a rule replaces a behavior of a previous rule, that previous rules behavior is then ignored. At the end, the system then aggregates the set of behaviors of active rules to be applied.

In accordance with an embodiment, the systems and methods can allow rule sets to be named, isolated, and deployable to the system dynamically. That means new rule sets can be introduced at any time. These rule sets should then be added to the list of rule sets run by the system. This allows the set of rule sets to expand dynamically based on what gets deployed to the system.

In accordance with an embodiment, the systems and methods can run the rules (passing in the current set of data and any environmental context), retrieve the results of that execution, then apply the behaviors. This aspect can have multiple implementations, all designed to run in a particular client or server environment. The aspect decides when and how often the rules should be run.

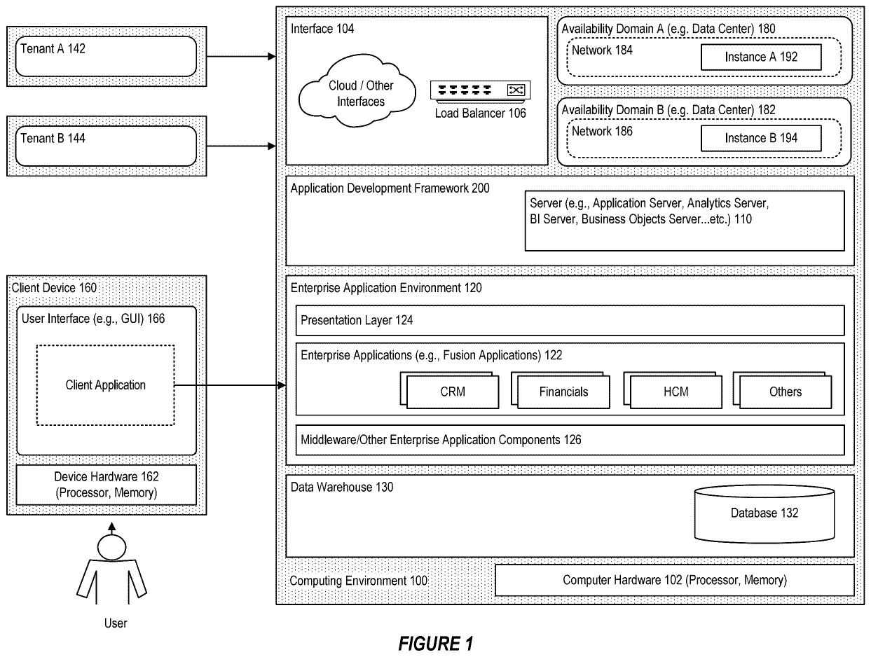

FIG. 1 illustrates an example server environment for portable and extensible system for dynamic user interfaces and data validation, in accordance with an embodiment.

In accordance with an embodiment, the components and processes illustrated in FIG. 1, and as further described herein with regard to various embodiments, can be provided as software or program code executable by a computer system or other type of processing device, for example a cloud computing system.

As illustrated in FIG. 1, in accordance with an embodiment, a cloud, SaaS, or other enterprise-computing environment 100 can operate on a computing infrastructure 102 comprising hardware (e.g., processor, memory), software resources, and one or more cloud or other application program interfaces (API) 104 that provide access to the shared resources via one or more load balancer 106.

In accordance with an embodiment, the environment supports the use of availability domains, such as for example availability domains A 180, and availability domains A B 182, which enables customers to access networks 184, 186, and (e.g., cloud or enterprise application) instances A 192, B 194.

For example, in accordance with an embodiment of a cloud or SaaS environment that supports access by tenants, each tenant A 142, B 144 can create, organize, and administer their cloud resources or instances.

In accordance with an embodiment, a client device, such as, for example, a computing device 160 having a device hardware 162 (e.g., processor, memory), and graphical user interface 166, can enable an administrator or other user to communicate with the environment via a network such as, for example, a wide area network, local area network, or the Internet.

In accordance with an embodiment, the system includes an enterprise application environment 120 (e.g., a Fusion Applications environment) that provides access to a variety of software enterprise applications 122 or other components, such as, for example, customer relationship management (CRM), Financials, human capital management (HCM), or other types of applications or components that can be used to access data stored in a data warehouse 130 or database 132 (for example, in a Fusion Applications environment, an Oracle Fusion Database).

In accordance with an embodiment, the enterprise application environment can include one or more presentation layer 124, or middleware/other enterprise application components 126 that facilitate access to the database, for storage and retrieval of table data.

### Application Development Framework

In accordance with an embodiment, an application development framework 200 is provided, wherein a rules engine component and rules are provided at both the client-side and the server-side, for use with a particular application. The rules engine and rules can be different implementations at each end. The client and server can communicate to exchange the latest versions of the rules; however the rules themselves are agnostic as to which (client-side or server-side) engine they are run on.

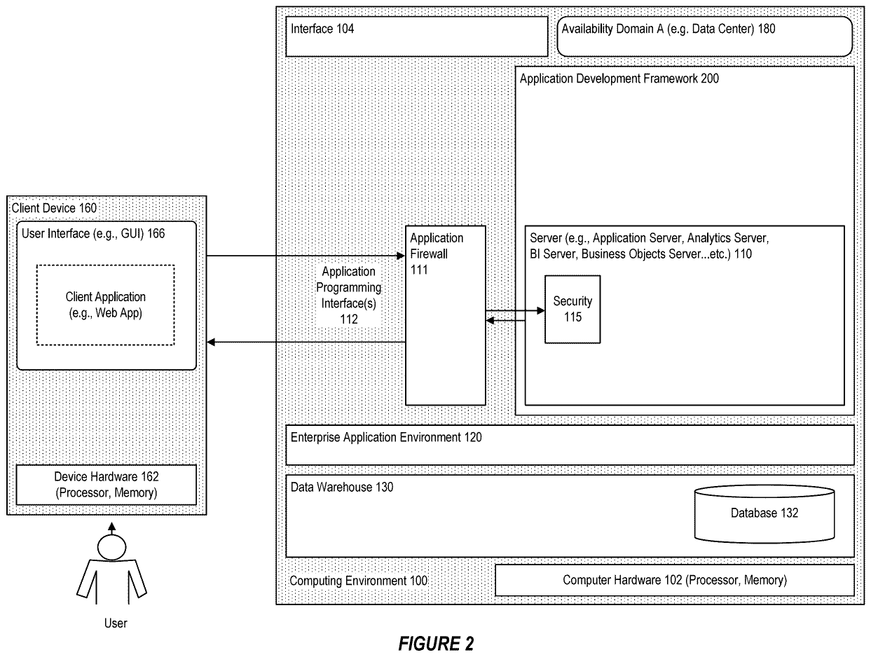

FIG. 2 illustrates an example server environment for portable and extensible system for dynamic user interfaces and data validation, in accordance with an embodiment.

In accordance with an embodiment, the components and processes illustrated in FIG. 2, and as further described herein with regard to various embodiments, can be provided as software or program code executable by a computer system or other type of processing device, for example a cloud computing system.

As illustrated in FIG. 2, in accordance with an embodiment, a cloud, SaaS, or other computing environment 100 (e.g., application server environment, analytics server environment, business intelligence server environment, business objects server environment) can operate on a computing infrastructure 102 comprising hardware (e.g., processor, memory), software resources, and one or more cloud or other application program interfaces (API) 112, opened by a server 110, that provide access to the resources and, e.g., databases 120, via an application firewall 111.

In accordance with an embodiment, the server 110 can be provided/run within the computing environment utilizing the computer hardware provided therein. The server can comprise any number of types of servers, including, but not limited to, an application server, an analytics server, a business intelligence server . . . etc. An application firewall 111 can be provided that can scan and monitor traffic from external sources (e.g., client device 160), and can be utilized to prevent or mitigate malicious traffic. Such traffic from client device 160 can access the computing environment, and the server therein, via one or more application programming interfaces opened/maintained by the server 110.

In accordance with an embodiment, a user of the client device 160, which comprises device hardware 162, can utilize a user interface 166 provided by or via the client device to access an application, such as a web application, which can be communicate with the computing environment as described above.

In accordance with an embodiment, upon receiving calls from the client and via one or more of the APIs provided by the server, the server defaults to a position that the calls from the client device are not authenticated and/or untrusted. In such situations, the server must re-authorize and/or check the data contained in the calls from the client device again (e.g., even if the client is perfectly matched). The server, for security purposes, must assume that the calls are malicious. The server can process such checks at security 115.

In accordance with an embodiment, such additional security checks can be performed as the server may not be aware of traffic from the client being intercepted and altered (e.g., maliciously) prior to reaching the firewall. This security 115 can comprise validations and security checks.

In accordance with an embodiment, functional security can be provided at the client. This functional security can be configured as a guide to be utilized by the user to indicate what information needs to be submitted for security purposes. Functional security can guide, for example, users to enter certain pieces of information, disallow other pieces of information (e.g., grey out), inform the user that certain pieces of information are off limits (e.g., based on a geographic location of the user) . . . etc. This is functional security can be provided and/or run on an application, such as web browser.

In accordance with an embodiment, there are advantages to functional security over a back-and-forth process between a client device and a server. Functional security is advantageous because feedback is immediate. A drawback, however, is that even though feedback is immediate, the server will still need to perform its own security checks for any communications/requests/data received from a client device, even a client device running functional security.

In accordance with an embodiment, another challenge with functional security is that the programming language used by a web application, for example, a browser, is likely not utilized by the server. Developers of functional security need to o write the same validations at the client level and at the server level, but in different languages. This ends up with duplication of work, and can also lead to a drifting between the security provided at the client and the security provided at the server.

In accordance with an embodiment, security is not just checks and validations but can also comprise presentation changes. For example, a user planning a trip may change a potential destination between different countries. Then, the presentation display may need to be updated based upon requirements of different countries (e.g., different visa requirements between countries). Then, the security provided at the client would need to again check with a server based upon such presentation changes, adding further delay.

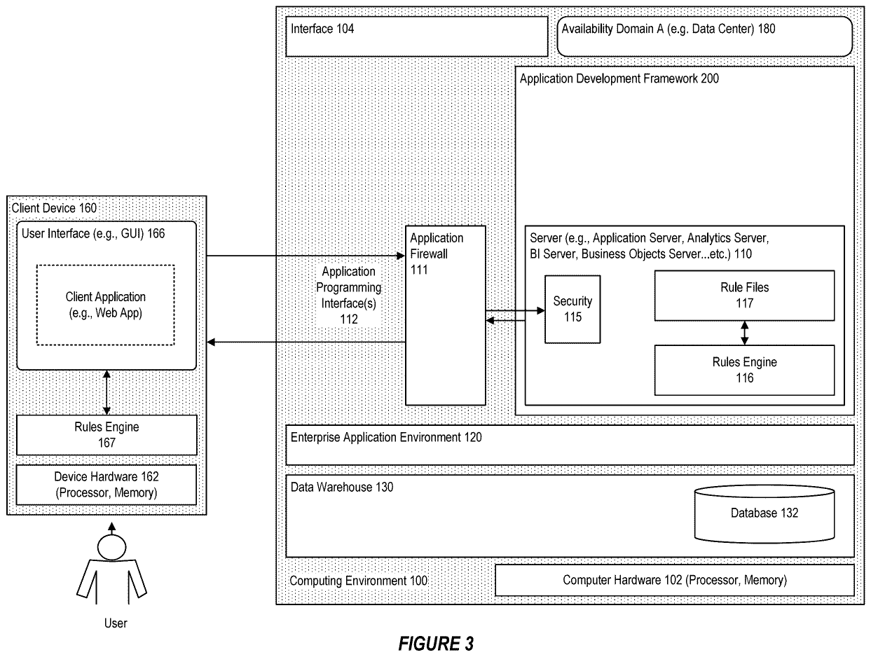

FIG. 3 illustrates an example server environment for portable and extensible system for dynamic user interfaces and data validation, in accordance with an embodiment.

In accordance with an embodiment, the components and processes illustrated in FIG. 3, and as further described herein with regard to various embodiments, can be provided as software or program code executable by a computer system or other type of processing device, for example a cloud computing system.

As illustrated in FIG. 3, in accordance with an embodiment, a cloud, SaaS, or other computing environment 100 (e.g., application server environment, analytics server environment, business intelligence server environment, business objects server environment) can operate on a computing infrastructure 102 comprising hardware (e.g., processor, memory), software resources, and one or more cloud or other application program interfaces (API) 112, opened by a server 110, that provide access to the resources and, e.g., databases 120, via an application firewall 111.

In accordance with an embodiment, the server 110 can be provided/run within the computing environment utilizing the computer hardware provided therein. The server can comprise any number of types of servers, including, but not limited to, an application server, an analytics server, a business intelligence server, a business object server . . . etc. An application firewall 111 can be provided that can scan and monitor traffic from external sources (e.g., client device 160), and can be utilized to prevent or mitigate malicious traffic. Such traffic from client device 160 can access the computing environment, and the server therein, via one or more application programming interfaces opened/maintained by the server 110.

In accordance with an embodiment, a user of the client device 160, which comprises device hardware 162, can utilize a user interface 166 provided by or via the client device to access an application, such as a web application, which can be communicate with the computing environment as described above.

In accordance with an embodiment, an embodiment, an implementation of a rules engine 116 can be provided/run at the server, and an implementation of a rules engine 167 can be provided/run at the client device.

In accordance with an embodiment, upon opening communications with the server, a set of rules can be downloaded, via an API 112, from the server to the be run at or in association with the rules engine 167 at the client device, and a same set of rules can be run at or in association with the rules engine 116 at the server. In this way, for example, both the client device and the server can operate, via each respective rules engine, according to the same set of rules (which can be pre-set or defined earlier).

In accordance with an embodiment, the server can be communicatively coupled to a set of rule files 117, where each file can comprise a rule set. Each rule set can be versioned. A rule set can comprise a series of rules that contain a condition and a behavior. The rule set can take as input a set of data that represents the data being examined or modified. It also takes in any relevant environmental context for rule evaluation.

In accordance with an embodiment, the rule files can be provided as an extensible system which allows multiple authors to contribute to the same files (e.g., rule sets) independently (while still maintaining portability).

In accordance with an embodiment, a rule condition can then examine the data set or the environmental context to determine whether or not it is active. If it is active, then the rule can provide a payload that describes what it is intended to do and also how to do it. This behavior may rely on the data set or environment context to further influence how that behavior is performed.

In accordance with an embodiment, each rules engine can then run the rules in series. If a rule replaces a behavior of a previous rule, that previous rule behavior is then ignored. At the end, the system then aggregates the set of behaviors of active rules to be applied.

In accordance with an embodiment, the rule sets can be named, isolated, and deployable to the system dynamically. That means new rule sets can be introduced at any time. These rule sets should then be added to the rule files run by the system. This allows the set of rule sets to expand dynamically based on what gets deployed to the system.

In accordance with an embodiment, the below are exemplary rules that can be utilized by the described systems and methods:

```
Rule 1:
if user.geography.region === “AMEA”, then...
  hide “salary” field
  make “days” field required
  set “contractorRate” field to = $45 x “days” field
Rule 2:
if user.role === “manager”, then...
  make “salary” field visible
Rule 3:
if someRecord.isFinished && tasks.incomplete, then...
  show error message: “You have incomplete tasks...”
```

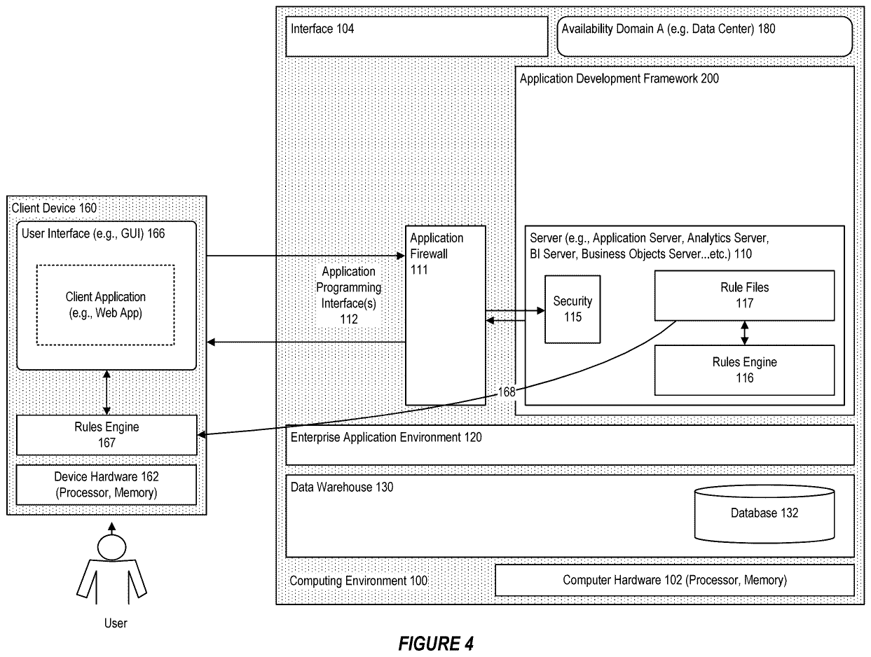

FIG. 4 illustrates an example server environment for portable and extensible system for dynamic user interfaces and data validation, in accordance with an embodiment.

In accordance with an embodiment, the components and processes illustrated in FIG. 4, and as further described herein with regard to various embodiments, can be provided as software or program code executable by a computer system or other type of processing device, for example a cloud computing system.

As illustrated in FIG. 4, in accordance with an embodiment, a cloud, SaaS, or other computing environment 100 (e.g., application server environment, analytics server environment, business intelligence server environment, business objects server environment) can operate on a computing infrastructure 102 comprising hardware (e.g., processor, memory), software resources, and one or more cloud or other application program interfaces (API) 112, opened by a server 110, that provide access to the resources and, e.g., databases 120, via an application firewall 111.

In accordance with an embodiment, the server 110 can be provided/run within the computing environment utilizing the computer hardware provided therein. The server can comprise any number of types of servers, including, but not limited to, an application server, an analytics server, a business intelligence server, a business object server . . . etc. An application firewall 111 can be provided that can scan and monitor traffic from external sources (e.g., client device 160), and can be utilized to prevent or mitigate malicious traffic. Such traffic from client device 160 can access the computing environment, and the server therein, via one or more application programming interfaces opened/maintained by the server 110.

In accordance with an embodiment, a user of the client device 160, which comprises device hardware 162, can utilize a user interface 166 provided by or via the client device to access an application, such as a web application, which can be communicate with the computing environment as described above.

In accordance with an embodiment, an embodiment, an implementation of a rules engine 116 can be provided/run at the server, and an implementation of a rules engine 167 can be provided/run at the client device.

In accordance with an embodiment, upon opening communications with the server, a set of rules can be downloaded, via an API 112, from the server to the be run at or in association with the rules engine 167 at the client device, and a same set of rules can be run at or in association with the rules engine 116 at the server. In this way, for example, both the client device and the server can operate, via each respective rules engine, according to the same set of rules (which can be pre-set or defined earlier).

In accordance with an embodiment, the server can be communicatively coupled to a set of rule files 117, where each file can comprise a rule set. Each rule set can be versioned. A rule set can comprise a series of rules that contain a condition and a behavior. The rule set can take as input a set of data that represents the data being examined or modified. It also takes in any relevant environmental context for rule evaluation.

In accordance with an embodiment, upon an access by the client device to the server, a copy of a relevant rule set from the rule files 117, in the form of a rule file, can be automatically downloaded to the rules engine of the client device. In this way, both the client device as well as the server, upon communication requiring security checks, can operate utilizing the same rules, having a same version.

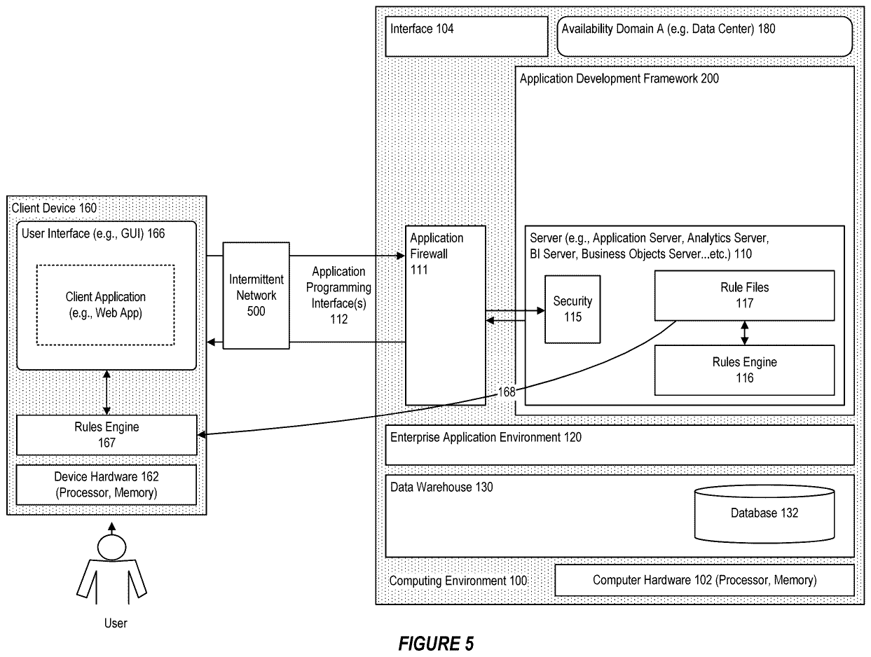

FIG. 5 illustrates an example server environment for portable and extensible system for dynamic user interfaces and data validation, in accordance with an embodiment.

In accordance with an embodiment, the components and processes illustrated in FIG. 5, and as further described herein with regard to various embodiments, can be provided as software or program code executable by a computer system or other type of processing device, for example a cloud computing system.

As illustrated in FIG. 5, in accordance with an embodiment, a cloud, SaaS, or other computing environment 100 (e.g., application server environment, analytics server environment, business intelligence server environment, business objects server environment) can operate on a computing infrastructure 102 comprising hardware (e.g., processor, memory), software resources, and one or more cloud or other application program interfaces (API) 112, opened by a server 110, that provide access to the resources and, e.g., databases 120, via an application firewall 111.

In accordance with an embodiment, the server 110 can be provided/run within the computing environment utilizing the computer hardware provided therein. The server can comprise any number of types of servers, including, but not limited to, an application server, an analytics server, a business intelligence server, a business object server . . . etc. An application firewall 111 can be provided that can scan and monitor traffic from external sources (e.g., client device 160), and can be utilized to prevent or mitigate malicious traffic. Such traffic from client device 160 can access the computing environment, and the server therein, via one or more application programming interfaces opened/maintained by the server 110.

In accordance with an embodiment, a user of the client device 160, which comprises device hardware 162, can utilize a user interface 166 provided by or via the client device to access an application, such as a web application, which can be communicate with the computing environment as described above.

In accordance with an embodiment, an embodiment, an implementation of a rules engine 116 can be provided/run at the server, and an implementation of a rules engine 167 can be provided/run at the client device.

In accordance with an embodiment, upon opening communications with the server, a set of rules can be downloaded 168, via an API 112, from the server to the be run at or in association with the rules engine 167 at the client device, and a same set of rules can be run at or in association with the rules engine 116 at the server. In this way, for example, both the client device and the server can operate, via each respective rules engine, according to the same set of rules (which can be pre-set or defined earlier).

In accordance with an embodiment, the server can be communicatively coupled to a set of rule files 117, where each file can comprise a rule set. Each rule set can be versioned. A rule set can comprise a series of rules that contain a condition and a behavior. The rule set can take as input a set of data that represents the data being examined or modified. It also takes in any relevant environmental context for rule evaluation.

In accordance with an embodiment, upon an access by the client device to the server, a copy of a relevant rule set from the rule files 117, in the form of a rule file, can be automatically downloaded to the rules engine of the client device. In this way, both the client device as well as the server, upon communication requiring security checks, can operate utilizing the same rules, having a same version.

In accordance with an embodiment, upon a client device maintaining a connection via an intermittent network connection 500, such as when a client device comprises a smart mobile device or a mobile computing device, and the device is utilized in an area without network connectivity, the rules engine 167 can remain active. In such situations, the rules engine can still provide security mechanisms at the client device, which can then store inputs related thereto until such time as the client device re-establishes communication via the intermittent network. In such situations, prior to uploading the data stored on the client device, the client device and/or the server can perform a check to ensure that the set of rules utilized by the rules engine 167 is still current. In some situations, rules can be updated periodically, such as on a monthly basis.

In accordance with an embodiment, the transfer/download 168 of the file comprising the rule set can, in a situation such as described above with regard to an intermittent network, be performed prior to the client device losing contact with the server, such as prior to going to a remote job site.

In accordance with an embodiment, a client device, upon contacting the server, can download/receive a latest copy of a relevant rule set.

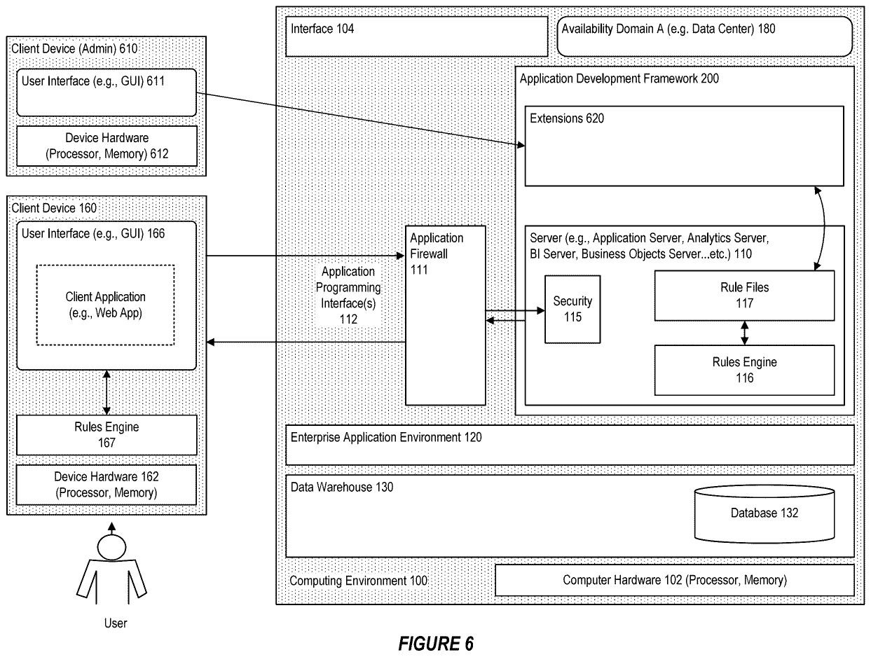

FIG. 6 illustrates an example server environment for portable and extensible system for dynamic user interfaces and data validation, in accordance with an embodiment.

In accordance with an embodiment, the components and processes illustrated in FIG. 6, and as further described herein with regard to various embodiments, can be provided as software or program code executable by a computer system or other type of processing device, for example a cloud computing system.

As illustrated in FIG. 6, in accordance with an embodiment, a cloud, SaaS, or other computing environment 100 (e.g., application server environment, analytics server environment, business intelligence server environment, business objects server environment) can operate on a computing infrastructure 102 comprising hardware (e.g., processor, memory), software resources, and one or more cloud or other application program interfaces (API) 112, opened by a server 110, that provide access to the resources and, e.g., databases 120, via an application firewall 111.

In accordance with an embodiment, the server 110 can be provided/run within the computing environment utilizing the computer hardware provided therein. The server can comprise any number of types of servers, including, but not limited to, an application server, an analytics server, a business intelligence server, a business object server . . . etc. An application firewall 111 can be provided that can scan and monitor traffic from external sources (e.g., client device 160), and can be utilized to prevent or mitigate malicious traffic. Such traffic from client device 160 can access the computing environment, and the server therein, via one or more application programming interfaces opened/maintained by the server 110.

In accordance with an embodiment, a user of the client device 160, which comprises device hardware 162, can utilize a user interface 166 provided by or via the client device to access an application, such as a web application, which can be communicate with the computing environment as described above.

In accordance with an embodiment, an embodiment, an implementation of a rules engine 116 can be provided/run at the server, and an implementation of a rules engine 167 can be provided/run at the client device.

In accordance with an embodiment, upon opening communications with the server, a set of rules can be downloaded, via an API 112, from the server to the be run at or in association with the rules engine 167 at the client device, and a same set of rules can be run at or in association with the rules engine 116 at the server. In this way, for example, both the client device and the server can operate, via each respective rules engine, according to the same set of rules (which can be pre-set or defined earlier).

In accordance with an embodiment, the server can be communicatively coupled to a set of rule files 117, where each file can comprise a rule set. Each rule set can be versioned. A rule set can comprise a series of rules that contain a condition and a behavior. The rule set can take as input a set of data that represents the data being examined or modified. It also takes in any relevant environmental context for rule evaluation.

In accordance with an embodiment, an authorized user, such as an admin user, can utilize a device, such as admin device 610, the admin device comprising a user interface 611 and device hardware 612, can interact with an extensions 620 module at the computing environment. Such interaction can comprise, for example, an authoring of client rules that can overwrite, modify, and/or overrule one or more rules of the rule sets within rule files 117.

In accordance with an embodiment, upon an access by the client device to the server, a copy of a relevant rule set from the rule files 117, in the form of a rule file, can be automatically downloaded to the rules engine of the client device. Prior to downloading or transferring such a rule set to the client device, the rule files/server/rules engine can check with extensions 620 to determine if any client rules set by an authorized user overwrite, modify, and/or overrule one or more rules of the rule sets to be transferred to the client device. Upon finding such rules, the rule set can be modified/appended/amended in such a way as to incorporate the client written rule sets. In this way, both the client device as well as the server, upon communication requiring security checks, can operate utilizing the same rules, having a same version.

In accordance with an embodiment, such client rules will also be utilized by the server in its security checks.

In accordance with an embodiment, client set rules (e.g., at extensions 620), can be configured within a rule set within rule files 117 such that the client set rules supersede and/or take priority over server-defined rule sets and/or previously defined client rule sets.

In accordance with an embodiment, an administrator (or other authorized user) on the client side can utilize tools to deploy to extensions a new rule or set of rules. When the server returns rules, the server can first check the extensions to determine whether there are any customer rules that are needed to overwrite or modify existing rules within the files.

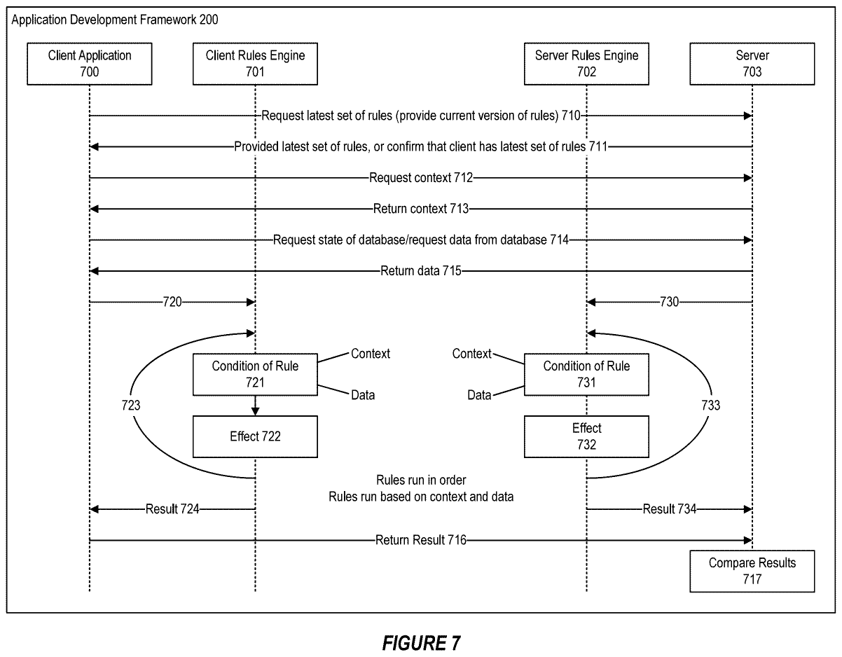

FIG. 7 illustrates an example flow chart for portable and extensible system for dynamic user interfaces and data validation, in accordance with an embodiment.

In accordance with an embodiment, a client 700 comprising a client rules engine 701 can initiate a process by requesting 710 a latest set of rules from a server 703. This latest set of rules can comprise, for example, a rule set from a database or files maintained by or accessible by the server 703. In certain embodiments, the latest set of rules may comprise a default and/or server/provider defined rule set. In certain other embodiments, the latest set of rules can comprise a client defined rule set, which can supersede a default or server/provider defined rule set. In certain other embodiments, a latest rule set can comprise a combination of a default and/or server/provider defined rule set and a client defined rule set.

In accordance with an embodiment, at 711, the server 703 can respond to the client 700 and provide a latest set of rules (e.g., rule set). In certain embodiments, the latest set of rules may comprise a default and/or server/provider defined rule set. In certain other embodiments, the latest set of rules can comprise a client defined rule set, which can supersede a default or server/provider defined rule set. In certain other embodiments, a latest rule set can comprise a combination of a default and/or server/provider defined rule set and a client defined rule set.

In accordance with an embodiment, at 712, the client 700 can request 712 a context from the server. Context can comprise certain information utilized in running the rule set, such as a latest exchange rate, a maximum billing rate, or any additional information/data that is utilized by the client rules engine 701 in running the provided rule set. At 713, the server 703 can return the requested context to the client 701. Rule sets can be run/rerun dynamically when either a current state of data or a context changes. For example, if a rule has a condition that checks for a field being true, if a user set that field to true in a user interface, the set of rules would be rerun, the rule would then apply, and its effect would take place.

In accordance with an embodiment, at 714, the client can request a state of a database and/or request data from a database from the server. Such data can comprise data to be utilized when the rule set is run at the client rules engine. For example, supposed a client is requesting to edit employee records. In such a case, the data requested from the database can comprise existing/current employee records. Such requested data can then be returned 715 from the server to the client.

In accordance with an embodiment, both the client rules engine 701 and the server rules engine can utilize a same set of rules (i.e., those requested and returned to the client at 710 and 711), together with the same context and data (provided at 720 and 730 respectively) to run the rule sets. Running the rule sets can comprise a process by which a condition of a rule 721/731 of the rule set is applied together with the context and the data, which results in an effect 722/732. Such a process can be run sequentially 723 and 733 with respect to all rules of a rule set until a result is returned at 724 and 734.

In accordance with an embodiment, these two processes at the client rules engine and the server rules engine can be run simultaneously or asynchronously.

In accordance with an embodiment, a result can be returned 716 from the client to the server, which can then compare the results 717. In this way, security can be achieved. In accordance with some embodiments, the server or other environment can run the same rules with the same context and input and accept that result. In this way, the results are not compared with the results from the client.

In accordance with an embodiment, rule sets can be run/rerun dynamically when either a current state of data, such as a user input, or a context changes. For example, if a rule has a condition that checks for a field being true, if a user set that field to true in a user interface, the set of rules would be rerun, the rule would then apply, and its effect would take place.

In accordance with an embodiment, the rules described above, together with their operation/application, is portable. The rules can be written in a generic format and use generic expressions like syntax to create rule conditions and effects. They include facilities to interpret and execute these rules in both a client and server environment. This makes the rule set portable so that it is authored once but can be applied in multiple supported environments.

### Example Method

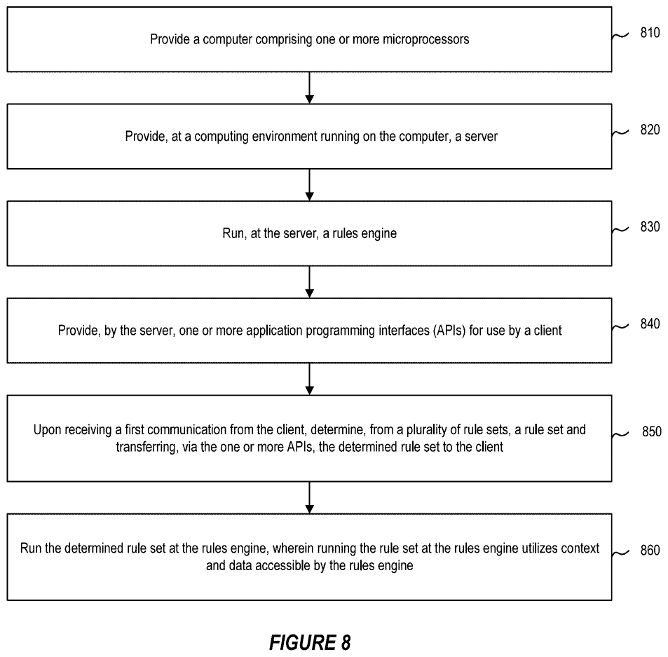

FIG. 8 is a flowchart of a method for portable and extensible system for dynamic user interfaces and data validation, in accordance with an embodiment.

In accordance with an embodiment, at step 810, the method can provide a computer comprising one or more microprocessors.

In accordance with an embodiment, at step 820, the method can provide, at a computing environment running on the computer, a server.

In accordance with an embodiment, at step 830, the method can run, at the server, a rules engine.

In accordance with an embodiment, at step 840, the method can provide, by the server, one or more application programming interfaces (APIs) for use by a client.

In accordance with an embodiment, at step 850, the method can, upon receiving a first communication from the client, determine, from a plurality of rule sets, a rule set and transferring, via the one or more APIs, the determined rule set to the client.

In accordance with an embodiment, at step 860, the method can run the determined rule set at the rules engine, wherein running the rule set at the rules engine utilizes context and data accessible by the rules engine.

### Example User Interface

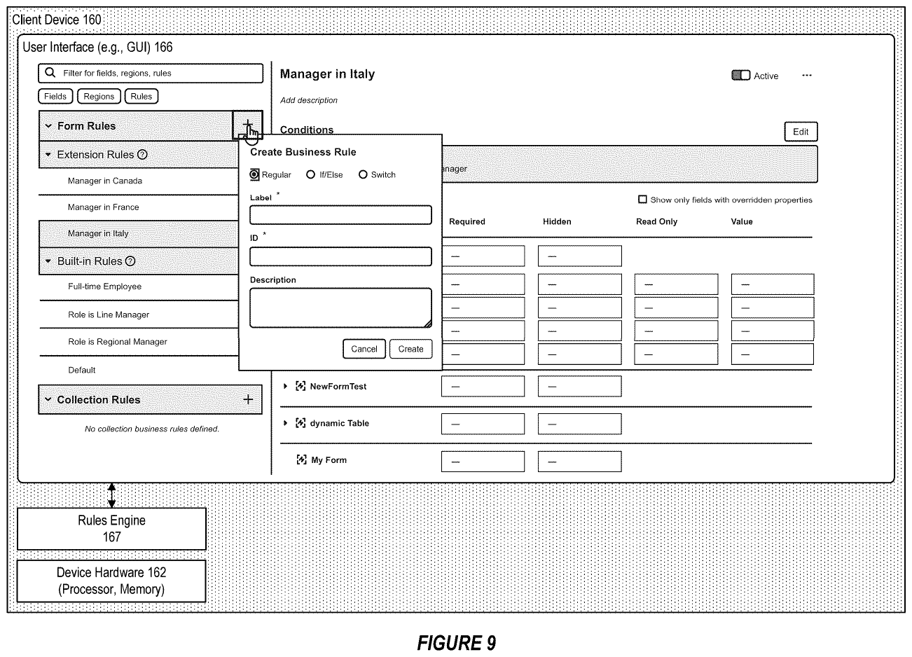

FIG. 9 illustrates an example user interface, in accordance with an embodiment.

In accordance with an embodiment, FIG. 9 illustrates an exemplary user interface 166 that can be displayed via, for example, a graphical user interface of a client device 160, the client device comprising device hardware 162 and a rules engine 167, as discussed above.

In accordance with an embodiment, the screenshot illustrated in FIG. 9 illustrates a screen in which a user can create a business rule. The rule can comprise a type, such as a regular rule, an if/else rule, or a switch rule. The rule can comprise a label, an identification (ID), and a description may be added as well.

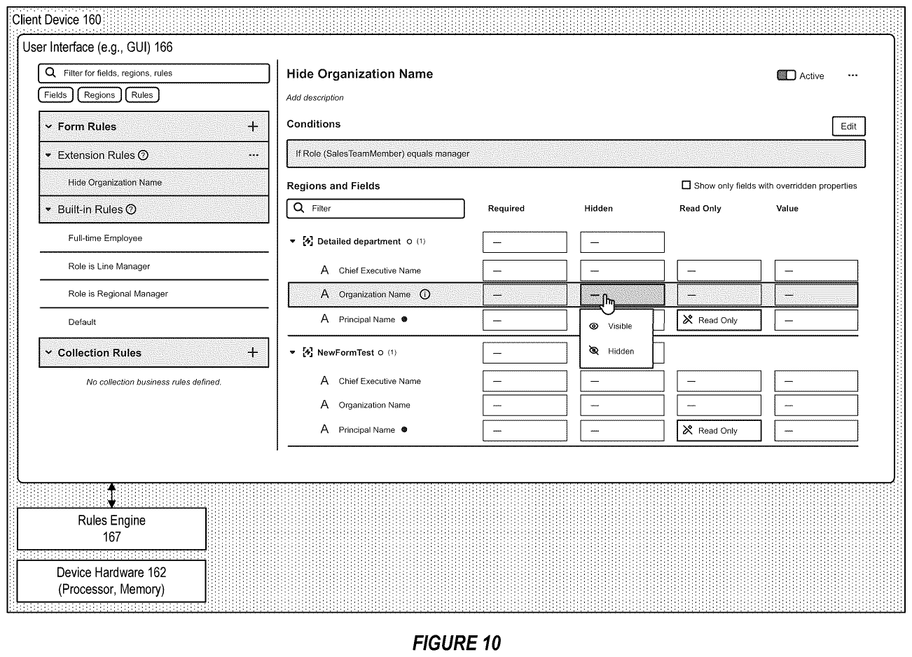

FIG. 10 illustrates an example user interface, in accordance with an embodiment.

In accordance with an embodiment, FIG. 10 illustrates an exemplary user interface 166 that can be displayed via, for example, a graphical user interface of a client device 160, the client device comprising device hardware 162 and a rules engine 167, as discussed above.

In accordance with an embodiment, the screenshot illustrated in FIG. 10 illustrates form rules. Selected in the screenshot is an extension rule “Hide Organization Name”. Displayed is conditions for the rule, and regions and fields of the rule. Also shown in the screenshot is a toggle indicating that the rule is active.

In accordance with various embodiments, the teachings herein can be implemented using one or more computer, computing device, machine, or microprocessor, including one or more processors, memory and/or computer readable storage media programmed according to the teachings herein. Appropriate software coding can readily be prepared by skilled programmers based on the teachings of the present disclosure, as will be apparent to those skilled in the software art.

In some embodiments, the teachings herein can include a computer program product which is a non-transitory computer readable storage medium (media) having instructions stored thereon/in which can be used to program a computer to perform any of the processes of the present teachings. Examples of such storage mediums can include, but are not limited to, hard disk drives, hard disks, hard drives, fixed disks, ROMs, RAMs, EPROMs, EEPROMs, DRAMs, VRAMs, flash memory devices, or other types of storage media or devices suitable for non-transitory storage of instructions and/or data.

The foregoing description has been provided for the purposes of illustration and description. It is not intended to be exhaustive or to limit the scope of protection to the precise forms disclosed. Further modifications and variations will be apparent to the practitioner skilled in the art.

For example, although several of the examples provided herein illustrate operation with an enterprise software application or data analytics environment such as, for example, an Oracle Analytics Cloud environment; in accordance with various embodiments, the systems and methods described herein can be used with other types of enterprise software application or data environments, cloud environments, cloud services, cloud computing, or other computing environments.

The embodiments were chosen and described in order to best explain the principles of the teachings herein and their practical application, thereby enabling others skilled in the art to understand the various embodiments and with various modifications that are suited to the particular use contemplated. It is intended that the scope be defined by the following claims and their equivalents.

What is claimed is:

1. A system for providing portable and extensible system for dynamic user interfaces and data validation, comprising:
a computer comprising one or more microprocessors;
wherein the one or more microprocessors are configured to perform steps comprising:
providing, at a computing environment running on the computer, a server;
running at the server a rules engine;
providing, by the server, one or more application programming interfaces (APIs) for use by a client;
upon receiving a first communication from the client, determining, from a plurality of rule sets, a rule set and transferring, via the one or more APIs, the determined rule set to the client; and
running the determined rule set at the rules engine, wherein running the rule set at the rules engine utilizes context and data accessible by the rules engine.

2. The system of claim 1,
wherein the determined rule set comprises a default rule set;
wherein the determined rule set comprises a plurality of rules; and
wherein running the determined rule set at the rules engine comprises running the plurality of rules in an ordered set by the determined rule set.

3. The system of claim 1,
wherein the determined rule set comprises a rule set configured based at least partially upon instructions received from the client rule set;
wherein the determined rule set comprises a plurality of rules; and
wherein running the determined rule set at the rules engine comprises running the plurality of rules in an ordered set by the determined rule set.

4. The system of claim 1,
wherein the context and data utilized by the rules engine is transferred, via the one or more APIs, to the client;
wherein the determined rule set is caused to be run at another rules engine provided at the client, the running the determined rule set at the another rules engine provided at the client utilizing the transferred context and data.

5. The system of claim 4,
wherein a result of the running the determined rule set at the another rules engine at the client is transferred, via the one or more APIs, to the server.

6. The system of claim 5,
wherein a result of the running the determined rule set at the rules engine at the server is compared with the result transferred from the client.

7. The system of claim 5,
wherein a result of the running the determined rule set at the rules engine at the server is accepted without comparing the result transferred from the client.

8. The system of claim 1,
wherein upon transferring the determined rule set, via the one or more APIs, to the client, the server loses communication with the client for a period of time;
wherein during the period of time in which the server loses communication with the client, wherein the determined rule set is caused to be run at another rules engine provided at the client; and
wherein upon communication with the client being reestablished, the rules engine runs the determined rule set at the rules engine, wherein running the rule set at the rules engine utilizes context and data accessible by the rules engine.

9. A method for providing portable and extensible system for dynamic user interfaces and data validation, comprising:
providing a computer comprising one or more microprocessors;
providing, at a computing environment running on the computer, a server;
running at the server a rules engine;
providing, by the server, one or more application programming interfaces (APIs) for use by a client;
upon receiving a first communication from the client, determining, from a plurality of rule sets, a rule set and transferring, via the one or more APIs, the determined rule set to the client; and
running the determined rule set at the rules engine, wherein running the rule set at the rules engine utilizes context and data accessible by the rules engine.

10. The method of claim 9,
wherein the determined rule set comprises a default rule set;
wherein the determined rule set comprises a plurality of rules; and
wherein running the determined rule set at the rules engine comprises running the plurality of rules in an ordered set by the determined rule set.

11. The method of claim 9,
wherein the determined rule set comprises a rule set configured based at least partially upon instructions received from the client rule set;
wherein the determined rule set comprises a plurality of rules; and
wherein running the determined rule set at the rules engine comprises running the plurality of rules in an ordered set by the determined rule set.

12. The method of claim 9,
wherein the context and data utilized by the rules engine is transferred, via the one or more APIs, to the client;
wherein the determined rule set is caused to be run at another rules engine provided at the client, the running the determined rule set at the another rules engine provided at the client utilizing the transferred context and data.

13. The method of claim 12,
wherein a result of the running the determined rule set at the another rules engine at the client is transferred, via the one or more APIs, to the server.

14. The method of claim 13,
wherein a result of the running the determined rule set at the rules engine at the server is compared with the result transferred from the client.

15. The method of claim 9,
wherein upon transferring the determined rule set, via the one or more APIs, to the client, the server loses communication with the client for a period of time;
wherein during the period of time in which the server loses communication with the client, wherein the determined rule set is caused to be run at another rules engine provided at the client; and
wherein upon communication with the client being reestablished, the rules engine runs the determined rule set at the rules engine, wherein running the rule set at the rules engine utilizes context and data accessible by the rules engine.

16. A non-transitory computer readable storage medium, including instructions stored thereon for providing portable and extensible system for dynamic user interfaces and data validation, which when read and executed by one or more computers cause the one or more computers to perform a method comprising:
providing, at the one or more computers, a server;
running at the server a rules engine;
providing, by the server, one or more application programming interfaces (APIs) for use by a client;
upon receiving a first communication from the client, determining, from a plurality of rule sets, a rule set and transferring, via the one or more APIs, the determined rule set to the client; and
running the determined rule set at the rules engine, wherein running the rule set at the rules engine utilizes context and data accessible by the rules engine.

17. The non-transitory computer readable storage medium of claim 16,
wherein the determined rule set comprises a default rule set;
wherein the determined rule set comprises a plurality of rules; and
wherein running the determined rule set at the rules engine comprises running the plurality of rules in an ordered set by the determined rule set.

18. The non-transitory computer readable storage medium of claim 16,
wherein the determined rule set comprises a rule set configured based at least partially upon instructions received from the client rule set;
wherein the determined rule set comprises a plurality of rules; and
wherein running the determined rule set at the rules engine comprises running the plurality of rules in an ordered set by the determined rule set.

19. The non-transitory computer readable storage medium of claim 16,
wherein the context and data utilized by the rules engine is transferred, via the one or more APIs, to the client;
wherein the determined rule set is caused to be run at another rules engine provided at the client, the running the determined rule set at the another rules engine provided at the client utilizing the transferred context and data.

20. The non-transitory computer readable storage medium of claim 16,
wherein upon transferring the determined rule set, via the one or more APIs, to the client, the server loses communication with the client for a period of time;
wherein during the period of time in which the server loses communication with the client, wherein the determined rule set is caused to be run at another rules engine provided at the client; and
wherein upon communication with the client being reestablished, the rules engine runs the determined rule set at the rules engine, wherein running the rule set at the rules engine utilizes context and data accessible by the rules engine.
